(19) United States
(12) Patent Application Publication
(10) Pub. No.: US 2003/0049393 A1
(43) Pub. Date: Mar. 13, 2003

(54) Transculent decorative panel

(76) Inventor: Marcello De Leo, London (GB)

Correspondence Address: Nath & Associates, 1030 15th Street N W Sixth Floor, Washington, DC, 20005, US

(21) Appl. No.: 10/239,891

(22) PCT Filed: Feb. 26, 2001
(86) PCT No.: PCT/EP01/02145

(30) Foreign Application Priority Data
Mar. 30, 2000 (GB) 00074794.1

(51) Int. Cl. E06B 3/24

(52) U.S. Cl. 428/34

(57) ABSTRACT

A translucent decorative panel is provided comprising two spaced, opposing transparent walls, securing means for fixedly securing said walls together to define a narrow recess therebetween, a layer of translucent beads disposed within said recess, and bead fixing means for fixing each of said beads in relation to said walls. Advantageously the beads may be arranged so as to reproduce a selected coloured pattern or image. A method and apparatus for manufacturing such a panel are also provided, which method and apparatus are preferably automated.

The present invention relates to a translucent decorative panel, which may be used as an ornamental or building component. The panel of the invention may be particularly suited for installation in back-lit objects such as windows, or internally-lit objects. such as lamps. The present invention also encompasses a method for manufacturing a decorative panel in accordance with the invention, and an automated device adapted for putting this method into effect.

Decorative stained glass panels have been known and manufactured for several centuries. Conventionally, a stained glass panel is manufactured according to the following method. Firstly, a pattern or image consisting primarily of a plurality of juxtaposed coloured areas is created, and pieces of coloured glass corresponding in size, shape and colour to each of the coloured areas are cut. These pieces are then joined together in accordance with the pattern or image by means of a plurality of lead strips that are H-shaped in transverse cross-section (“lead came”). The lead strips are spot-welded together at points of intersection by soldering on both sides of the assembled glass panel. Finally, a sealant or mastic waterproofing material is inserted between the glass surface and the juxtaposed flange of lead came on either side of the glass panel, in order to prevent the ingress of water or other fluids into the joint between adjacent glass sheets.

Stained glass panels assembled according to this technique suffer from several short-comings. Firstly, as is evident from the above description, the cut glass sheets forming a panel assembled in this way are supported and held primarily by the strips of lead came which serve to join the sheets together. If the sheets exceed a certain size or weight, or if the panel is to be subjected to rough handling or violent weather conditions (for example, following installation of the panel in a door or a window), it is likely that the degree of support afforded by the lead came alone will be insufficient to hold the glass sheets together in the panel. Accordingly, it is generally necessary or advisable when installing such a panel to provide horizontal or vertical reinforcing bars for holding the glass sheets in place. Such bars are unsightly and detract from the aesthetic appeal of the stained glass panel, and in particular render the image constructed in the glass properly visible from one side of the panel only. The stained glass panel is therefore asymmetric about its centre plane.

Secondly, whilst the technique described above is suited for the reproduction of crude designs or patterns which consist mainly of heavily outlined blocks of colour, it is less amenable to the creation of a panel displaying a more finely detailed or nuanced image, such as a picture comprising gradations of shading and colour with no clear outlines.

There remains therefore an outstanding need in the art for an alternative, translucent decorative panel. which panel is bi-directional and may comprise a detailed coloured image, and which has a sufficient inherent strength to obviate the need for reinforcing bars to support the panel following installation in a window or door.

In accordance with one aspect of the invention therefore there is provided a translucent decorative panel comprising two spaced, opposing transparent walls, securing means for fixedly securing said walls together to define a narrow recess therebetween, a layer of translucent beads disposed within said recess, and bead fixing means for fixing each of said beads in relation to said walls.

Said beads are fixedly held within said recess between said two opposing transparent walls, and are thereby protected from being dislodged during rough handling of the panel or exposure of the panel to violent weather conditions. The layer of beads is supported by each of the two opposing walls, which walls will each typically comprise a single sheet of a rigid self-supporting material. Hence, the need for reinforcing bars to support the panel following installation in a door or window frame is not envisaged.

In accordance with a second aspect of the present invention, there is provided a method of manufacturing a translucent decorative panel, comprising the steps of providing first and second transparent walls, fixedly securing said walls together in opposing spaced relation to define a narrow recess therebetween, and fixing between said walls in the recess a layer of translucent beads.

In particularly preferred embodiments, said beads are arranged between said walls so as to define a predetermined pattern, which pattern may comprise an ordered pattern or image. The passage of light through said panel will illuminate the layer of beads, thereby enabling an onlooker to visualise said pattern. Advantageously, said layer of beads comprises a single layer, so that said pattern is created by the juxtaposition of individual beads within said layer.

Preferably, some or all of said beads are coloured. Said beads may all comprise the same colour or no colour, but preferably said beads include a plurality of types of beads, each of which types comprises a different colour or shade of colour. Accordingly, said pattern may advantageously include or consist of a pattern of colours or coloured image. Said pattern of colours or coloured image is created by the juxtaposition of individual beads within said layer, and so depending on the size and the colouring of the beads, a complex image having a wealth of detail and shading may be generated within the panel. Advantageously, between 2 and 1000 different types of beads, each comprising a different colour or shade of colour, may be provided. Preferably, however, 50-500, more preferably 100-300, still more preferably 256 different types of beads are provided.

Preferably, said layer of beads may comprise a plurality of beads disposed closely adjacent or contiguous one another. Advantageously, said beads may each comprise the same shape or a similar shape, such that the beads are enabled to lie contiguously within said layer in a regular array. Said beads may be spherical or substantially spherical. Thus, the beads may be arranged within said layer to form blocks or rows of beads bounded by straight lines and/or by curving lines.

Said walls may be flat or curved in configuration. Where the panel is to be installed (for example) in a door or a window, said walls may preferably be flat or substantially flat. However, where said panel is intended for installation in a cylindrical column, or curved lamp glass (for example), said walls may be curved; the degree of curvature of each wall being selected in accordance with the desired use.

Said bead fixing means may conveniently comprise an adhesive such as a transparent or translucent glue. Optionally, said adhesive may comprise a continuous layer of glue applied to the inner surface of at least one of said walls, such that said beads can be fixed in relation to said at least one wall. Glues and adhesives suitable for this purpose will be familiar to the man skilled in the art, and are commercially available.

Said securing means may comprise a web interposed between said two opposing walls, which web is fixedly attached to each of said walls and serves to define said recess between the walls. Said web may for example be fixedly attached to each of said walls by means of an adhesive. Alternatively or in addition, mechanical fixing means, such as a plurality of threaded nuts and bolts, may be provided for fixing said web to each of said walls. In some embodiments, said web may comprise a frame extending around the periphery of each of said plates, and said layer of beads may be disposed within said frame, such that said frame does not obscure said pattern of beads. Advantageously, said beads may be tightly packed within said frame, and may be held in place by said frame.

Said two opposing walls may be arranged such that the width of said recess between the walls is substantially the same as the diameter of each bead, so that each of said beads contacts both of said walls and is tightly sandwiched between said walls. Typically, the diameter of each bead and/or the width of said recess between the walls may be less than 10 mm, typically less than 5 mm, preferably between 2 and 5 mm.

Optionally, said panel may comprise boundary means for dividing said recess into a plurality of distinct regions, each of which regions contains a plurality of beads comprising the same colour or a similar colour. Said boundary means may, for example, comprise one or more wires. The provision of boundary means within said layer of beads may serve to define and delineate said pattern.

Preferably, said beads and/or each of said walls may be formed from glass. Thus, the panel may, for example, be adapted to be installed in a window or door frame, in place of a conventional glass pane.

In particularly preferred embodiments, a panel in accordance with the present invention includes a layer of beads comprising a pattern, which pattern reproduces a selected original image, preferably a coloured original image. Accordingly, the method of the present invention may further comprise the steps of translating said original image into an array of contiguous pixels according to the desired size of said pattern on the panel, each of which pixels corresponds to an individual bead; selecting a colour determinant for association with each pixel according to the colour or shade of said pixel; selecting a bead corresponding to each pixel according to the colour determinant associated with said pixel; and arranging the selected beads within said layer in accordance with the arrangement of pixels within said array, so as to reproduce said original image in the panel. Said colour or shade of the pixel may conveniently be taken to be the predominant colour or shade of the pixel.

Conveniently, a predetermined number of types of bead may be provided, each type having a different colour or shade; and said method may further include the step of assigning a unique colour determinant to each type of bead, according to the colour or shade of the type. In order to achieve faithful reproduction of said original image on the panel, therefore, the colour determinant selected for association with each pixel in accordance with the method of the present invention may advantageously be that assigned to a bead type having a colour or shade closely similar or identical to the colour or shade of said pixel in said original image.

In preferred embodiments, the method of the present invention is automated. Hence, the method of the present invention may comprise the steps of storing said original image electronically; processing the stored image to provide instruction data representing the array of pixels and the colour determinant associated with each pixel in said array; and thereafter automatically arranging said beads within said layer in accordance with said instruction data.

Moreover, in accordance with a further aspect of the present invention there is provided apparatus for manufacturing a translucent decorative panel in accordance with the present invention, said apparatus comprising means for storing electronically a preselected original image for reproduction on said panel; processing means for translating said stored image into an array of contiguous pixels according to the desired size of the reproduced image on said panel such that each pixel corresponds to a single bead, selecting a colour determinant for association with each pixel according to the colour or shade of the pixel in said original image, and creating instruction data which represents said array of pixels and the colour determinant associated with each pixel in the array; a plurality of bead holding compartments, each of which is adapted to store a reservoir of identical or closely similar translucent beads, each of said compartments being associated with a single colour determinant according to the colour or shade of the beads stored in said compartment; and means for selectively delivering beads from said bead holding compartments to a first transparent wall of said panel and arranging said beads on said wall in accordance with said instruction data, so as to produce a pattern of beads which reproduces said preselected original image. Said preselected original image may, conveniently, be scanned into said apparatus.

Advantageously, said means for selectively delivering and arranging said beads comprises support means adapted to support said first transparent wall, and bead dispensing means adapted to dispense and transport beads from each selected bead holding compartment to said wall for placement thereon in accordance with said instruction data. Said means for selectively delivering and arranging said beads may, for example, comprise a robotic device.

Following is a description, by way of example only and with reference to the accompanying drawings, of embodiments of the present invention.

In the drawings:

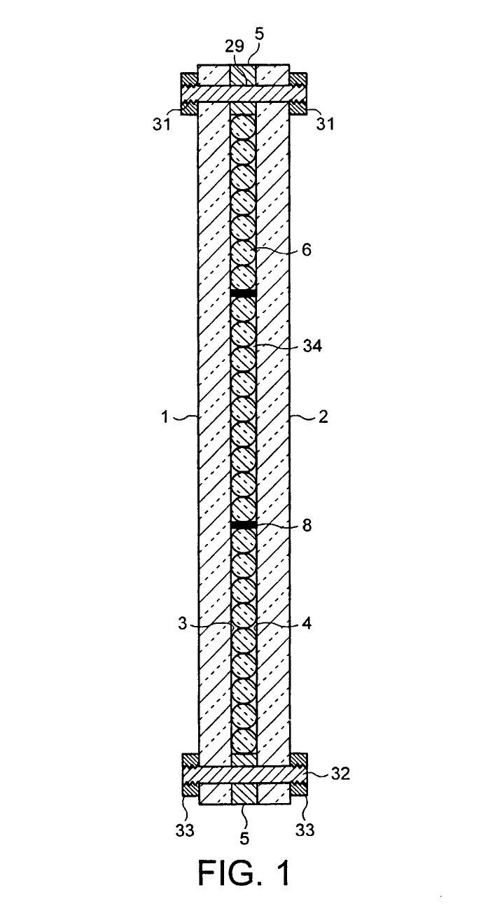

FIG. 1 shows a sectional side view of a decorative panel in accordance with the invention.

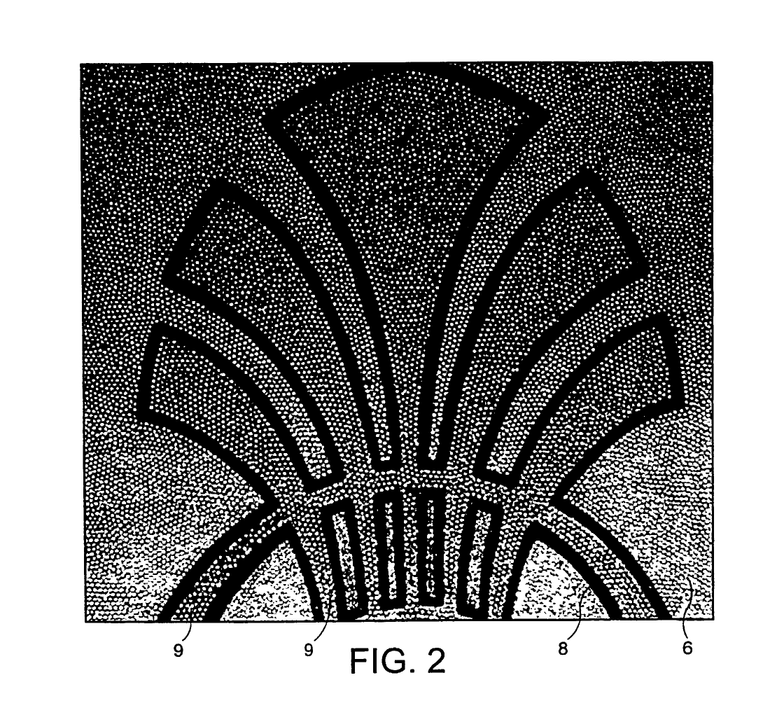

FIG. 2 shows a front view of a part of a decorative panel in accordance with the present invention.

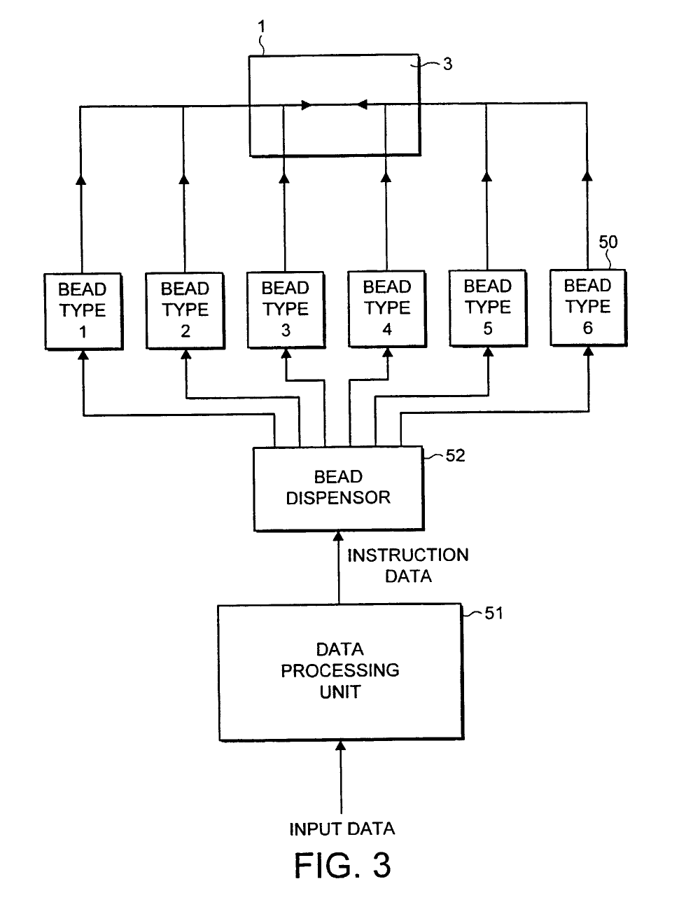

FIG. 3 is a schematic diagram illustrating a robotic device in accordance with the present invention.

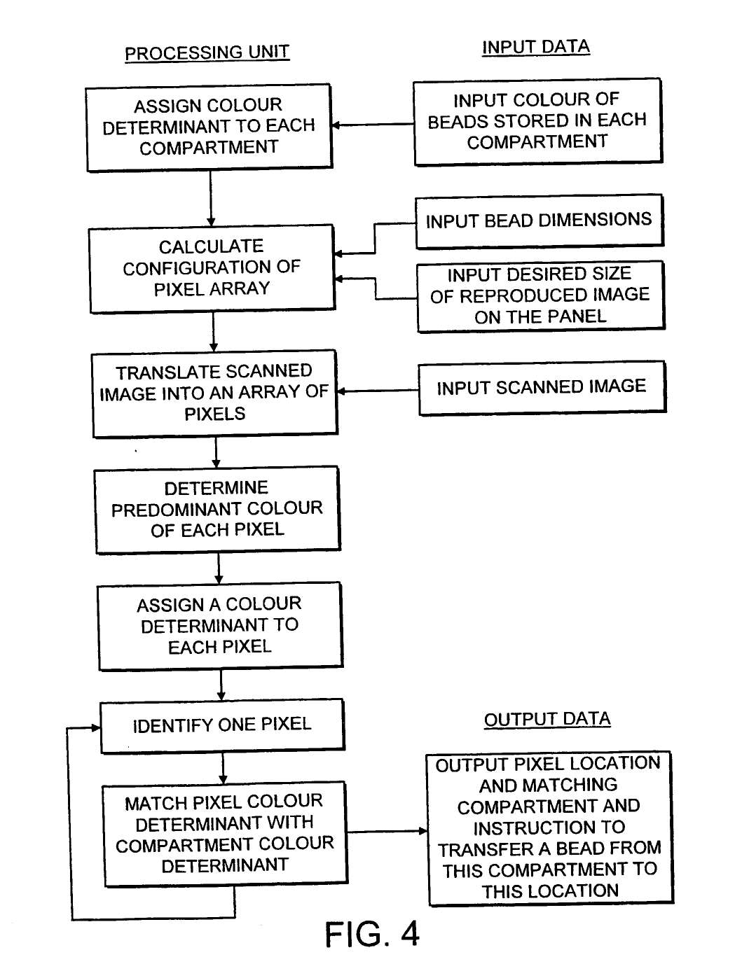

FIG. 4 is a flow chart setting out the steps by which instruction data is generated by a processing unit for the automated manufacture of a decorative panel in accordance with the invention.

A decorative panel in accordance with the present invention comprises first and second flat glass sheets 1 and 2, each sheet having at least one flat face (3, 4). A peripheral frame 5, shaped to extend around the periphery of said flat face 3, 4 of each sheet, is provided, said frame comprising a plurality of bores 29 which are arranged to communicate with corresponding bores 30, 31 provided around the periphery of glass sheets 1 and 2 respectively. A stem 32 that is threaded at both ends extends through each bore 29 in frame 5 and through the corresponding bores 30 and 31 in sheets 1 and 2 respectively, and is mated at both ends thereof with corresponding screw-threaded nuts 33, which serve to fasten said sheets 1 and 2 tightly together with said frame 5 sandwiched therebetween. A narrow recess 34 is thereby defined between the sheets.

A plurality of coloured, uniformly spherical glass beads 6 are provided, which beads are sandwiched in a single flat layer in said recess 34 within the bounds of said frame 5. Said glass beads 6 may be manufactured following a variety of methods well known to the man skilled in the art. For example, such beads may be produced by passing finely fritted glass through a hot flame; or by blowing; or by other methods known to the man skilled in the art. Coloured beads suited for this purpose are commercially available. Said beads 6 include a plurality of types of beads, each of which types has a different colour or shade of colour. Beads 6 are arranged within said single flat layer in a predetermined pattern of colours, each bead 6 being affixed to said faces 3 and 4 by means of a transparent glue. A plurality of wires 8 are provided within said single flat layer of beads 6, for separating the beads into a plurality of distinct regions, thereby improving or enhancing the definition of said pattern of beads.

A front view of a part of a decorative panel in accordance with the present invention is shown in FIG. 2. In the embodiment shown in this figure, a layer of coloured beads 6 interposed two glass sheets (not shown) is provided, and a plurality of wires 8 are provided within said layer of beads 6 for defining a plurality of distinct regions 9 within said layer. Each region 9 comprises a plurality of beads having substantially the same colour, such that a striking pattern is created.

A decorative panel as shown in FIGS. 1 and 2 may be made as follows. Firstly, said frame 5 is placed on said face 3 of glass sheet 1 so as to extend around the periphery thereof, the frame being arranged such that each of said bores 29 communicates with a corresponding bore 30 provided in said sheet 1. A stem 32 that is threaded at both ends is entered through each of said bores 29 and corresponding bore 30, such that the two opposing ends of each stem 32 protrude from the openings of bores 29 and 30 respectively. A nut 33 is screwed on to the end of each stem 32 protruding from said opening of the bore 30 in sheet 1. Stems 32 thus serve to hold said frame 5 on said sheet 1.

Wires 8, formed into an appropriate configuration so as to define a plurality of distinct regions 9, are placed on said face 3 of said glass sheet 1 within the bounds of said frame 5. A plurality of beads 6 are then assembled within each region 9 defined by the wires 8, so as to form a single flat layer of beads 6. The whole of said face 4 of said glass sheet 2 is coated with a transparent glue, and the glass sheet 2 is placed onto the assembly of sheet 1, frame 5 and beads 6, such that said face 4 contacts and adheres to said beads 6 and said wires 8. Each bore 31 in the glass sheet 2 is threaded over the end of a stem 32 protruding from one of said bores 29 in said frame 5, such that said end of the stem protrudes from the opening of said bore 31. A nut 33 is screwed onto said end of the stem 32. thereby tightly securing together said glass sheets 1 and 2 with said glass frame 5 and beads 6 sandwiched therebetween.

After thorough drying of the glue, the decorative panel can be installed in a suitable frame, such as a window frame or door frame.

Said beads 6 may be assembled on said face 3 of the sheet 1 by hand, so as to produce a selected pattern. However, said beads 6 may alternatively be assembled automatically on said face 3 of the sheet 1 by a robotic device in accordance with instruction data provided by a computer, so as to reproduce a chosen image. FIG. 3 is a schematic diagram illustrating a robotic device adapted for assembling said beads 6 on said sheet 1, whilst FIG. 4 shows a flow chart setting out the steps by which said instruction data may be generated.

As shown in FIG. 3, a robotic device in accordance with the present invention comprises a plurality of bead-holding compartments 50, a data processing unit 51, and a bead dispensor 52. Each bead-holding compartment 50 is adapted to store a reservoir of identical or substantially identical beads 6. Each reservoir of beads has a different colour or a different shade of colour. Said bead dispensor 52 is connected to said processing unit 51 and, in response to instruction data inputted to said processing unit 51, is adapted to dispense and transport a bead from a selected bead-holding compartment 50 to a selected location on said face 3 of said glass sheet 1 for placement thereon.

FIG. 4 illustrates the generation of said instruction data in said processing unit 51. Firstly, data identifying the colour of the beads stored in each bead-holding compartment 50 is entered into the processing unit, and the unit assigns a colour determinant with each bead-holding compartment according to the colour of the beads stored therein. Data identifying the dimensions of each bead 6, and the desired dimensions of the reproduced image, is entered into the processing unit, and the unit calculates the configuration of a contiguous pixel array wherein each pixel corresponds to one bead. A chosen original image, stored in electronic form (such as a scanned image) is entered into the processing unit. The unit translates the stored original image into an array of pixels having the configuration previously calculated. The processing unit identifies the predominant colour of each pixel in the array, and assigns to each pixel a colour determinant according to this colour. Finally, the processing unit identifies each pixel in the array in turn, matches the colour determinant assigned to the pixel with the colour determinant associated with one of said bead-holding compartments 50, and outputs as instruction data the instruction to dispense a bead from that bead-holding compartment and place the bead on the part of the glass sheet 1 which corresponds to the location of the pixel in the array. In this way, a pattern of beads corresponding to the original scanned image is built up on the surface of glass sheet 1, ready for incorporation into a decorative panel in accordance with the invention.

1 A translucent decorative panel comprising two spaced, opposing transparent walls, securing means for fixedly securing said walls together to define a narrow recess therebetween, a layer of translucent beads disposed within said recess, and bead fixing means for fixing each of said beads in relation to said walls.

2 A panel as claimed in claim 1, wherein said beads are arranged between said walls so as to define a predetermined pattern, which pattern may comprise an ordered pattern or image, such as a pattern of colours or coloured image.

3 A panel as claimed in claim 1 or claim 2, wherein some or all of said beads are coloured.

4 A panel as claimed in claim 3, wherein said beads include between 2 and 1000 different types of beads, each of which types comprises a different colour or shade of colour.

5 A panel as claimed in any preceding claim, wherein said layer of beads comprises a plurality of beads disposed closely adjacent or contiguous one another.

6 A panel as claimed in any preceding claim, wherein each wall comprises a single sheet of a rigid self-supporting material and is flat or curved in configuration.

7 A panel as claimed in any preceding claim, wherein said bead fixing means comprises an adhesive such as a transparent or translucent glue.

8 A panel as claimed in any preceding claim, wherein said securing means comprises a web interposed between said two opposing walls, which web is fixedly attached to each of said walls and serves to define said recess between the walls.

9 A panel as claimed in claim 8, wherein said web comprises a frame extending around the periphery of each of said plates, said layer of beads being disposed within said frame such that said frame does not obscure said layer of beads.

10 A panel as claimed in any preceding claim, wherein the diameter of each bead and/or the width of said recess between the walls is less than 10 mm, typically less than 5 mm, preferably between 2 and 5 mm.

11 A panel as claimed in any preceding claim, wherein said panel comprises boundary means for dividing said recess into a plurality of distinct regions, each of which regions contains a plurality of beads comprising the same colour or a similar colour.

12 A method of manufacturing a translucent decorative panel in accordance with any of claims 1-11, comprising the steps of providing first and second transparent walls, fixedly securing said walls together in opposing spaced relation to define a narrow recess therebetween, and fixing between said walls in the recess a layer of translucent beads.

13 A method as claimed in claim 12 appended to claim 2, further comprising the steps of translating said ordered coloured pattern or image into an array of contiguous pixels according to the desired size of said pattern or image on the panel, each of which pixels corresponds to an individual bead; selecting a colour determinant for association with each pixel according to the colour or shade of said pixel; selecting a bead corresponding to each pixel according to the colour determinant associated with said pixel; and arranging the selected beads within said layer in accordance with the arrangement of pixels within said array, so as to reproduce said ordered pattern or image in the panel.

14 A method as claimed in claim 12 appended to claim 2, or claim 13, further comprising the steps of storing said pattern or image electronically; processing the stored pattern or image to provide instruction data representing the array of pixels and the colour determinant associated with each pixel in said array; and thereafter automatically arranging said beads within said layer in accordance with said instruction data.

15 A method as claimed in any of claims 12-14, which method is automated.

16 Apparatus for manufacturing a translucent decorative panel in accordance with claim 2 or any of claims 3-11 when dependent on claim 2, said apparatus comprising means for storing electronically said pattern or image for reproduction on said panel; processing means for translating said stored pattern or image into an array of contiguous pixels according to the desired size of the reproduced pattern or image on said panel such that each pixel corresponds to a single bead, selecting a colour determinant for association with each pixel according to the colour or shade of the pixel in said pattern or image, and creating instruction data which represents said array of pixels and the colour determinant associated with each pixel in the array; a plurality of bead holding compartments, each of which is adapted to store a reservoir of identical or closely similar translucent beads, each of said compartments being associated with a single colour determinant according to the colour or shade of the beads stored in said compartment; and means for selectively delivering beads from said bead holding compartments to a first transparent wall of said panel and arranging said beads on said wall in accordance with said instruction data. so as to produce a pattern of beads which reproduces said preselected pattern or image.

17 Apparatus as claimed in claim 16, wherein said means for selectively delivering and arranging said beads comprises support means adapted to support said first transparent wall, and bead dispensing means adapted to dispense and transport beads from each selected bead holding compartment to said wall for placement thereon in accordance with said instruction data.

18 Apparatus as claimed in claim 16 or claim 17, which apparatus comprises a robotic device.
